(19) United States
(12) Patent Application Publication
(10) Pub. No.: US 2003/0157905 A1
(43) Pub. Date: Aug. 21, 2003

(54) Transmitter and associated method for reducing the adjacent channel power during wireless communications

(75) Inventor: Peter Bo Holmqvist, Apex, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Matsushita Electric Industrial Co., Ltd.

(21) Appl. No.: 10/079,081

(22) Filed: Feb. 18, 2002

(51) Int. Cl. H04B 1/02

(52) U.S. Cl. 455/102; 455/108

(57) ABSTRACT

A transmitter for improving the spectral characteristics of a transmitted output signal includes a phase modulator for receiving a signal and modifying the phase of the signal, a power amplifier for receiving the phase modified signal from the first operation and amplifying the phase modified signal, and an amplitude modulator for receiving the amplified phase modified signal and modifying the amplitude of the amplified phase modified signal. Although the phase and amplitude modulation are performed separately in order to minimize the amplitude distortion without complicating the design of the phase modulator, the combined effect of the phase and amplitude modulation is to filter the out of band spectral emissions of the transmitted output signal. Additionally, the transmitter can store the phase shift and amplitude modulation information in a table for a variety of different input data sequences such that the phase shift and amplitude modulation information need merely be looked up in the table as opposed to being calculated in response to each digital signal input.

### FIELD OF THE INVENTION

The present invention relates to an apparatus and method for spectral improvement of radio frequency emissions, and more specifically, to an apparatus and method for reducing Adjacent Channel Power for wireless communications.

### BACKGROUND OF THE INVENTION

The radio frequency spectrum is a valuable resource used by an enormous amount of entities, including radio stations, wireless communication companies, the military, and even personal users. Because the radio frequency spectrum is valuable, and used by a large variety of entities, its use is controlled by international law. For example, typical regulations include the breadth of the spectrum (i.e., located around a center frequency) one entity may utilize for a given application, and the maximum amount of power which may be transmitted by that entity outside of that given spectrum. If entities were unregulated, many RF signals would interfere with each other so that RF transmission would be distorted outside of a radius very near each transmitter. For example, a consumer wishing to listen to a car radio might constantly receive multiple radio stations for any tuned frequency if RF regulations were not adhered to by the radio stations. Thus, in many circumstances, it is important to consume as little of the RF spectrum as possible.

The present invention is a novel method to reduce the bandwidth, or more specifically, the Adjacent Channel Power (ACP), for wireless communication transmitters utilizing Continuous Phase Modulation (CPM) or other near constant envelope modulation schemes. The Adjacent Channel Power is defined as the power a transmitter is emitting in the neighboring frequency channels to the frequency band of the modulation. In this regard, the frequency band of the modulation has a bandwidth that is typically defined as the minimum frequency span containing 99% of the transmitted power. As a result, reducing or removing the ACP only affects a very small portion of the total signal power, albeit a sufficient portion to cause significant interference on neighboring spectral channels. Although unwanted spectral emissions from radio transmitters have been previously dealt with in a variety of manners, each method is in part inadequate due to problems associated with their implementation.

One way in which unwanted spectral emissions from a radio transmitter are limited is by filtering the transmitter output signal. According to this method, the frequency response of the filter can be selected such that the unwanted emissions are reduced to an acceptable level. Although removing part of the transmitted spectrum will distort the modulation, if the purpose of the filter is to lower the ACP, the distortion can be small or negligible. However, placing an ACP reducing filter at the output of the transmitter presents several problems: the filter must have very sharp band-pass characteristics, it must have low pass-band loss and if the transmitter output frequency is changed the filter must be tuned accordingly. Consequently this approach is rarely used.

A more commonly used approach is to place a filter either at baseband or at an intermediate frequency (IF) to reduce unwanted spectral emissions. If the filtering is introduced at baseband, the filter can have an easily implemented low-pass characteristic. On the other hand, if the filter is placed at an intermediate frequency, it must have band-pass characteristics. The IF is usually much lower in frequency than the transmitted signal, which makes the filter easier to implement. Additionally, the IF is fixed, such that it does not change with changes in the output frequency of an RF transmitter. Another advantage of these implementations is that neither the filter at baseband nor the filter at IF has to handle the full output power, making issues of insertion loss and power handling much less critical.

Nonetheless, placing filters at baseband or at IF does result in some drawbacks. The primary drawback with placing a filter at IF or at baseband is caused by the amplitude variations introduced by the filter. If the transmitter chain contains non-linear elements after the filter, these amplitude variations are not accurately reproduced at the antenna. Therefore, much of the spectral improvements gained by the filter can be lost if the amplitude variations are distorted. Examples of non-linear elements causing this distortion are a Power Amplifier (PA) and Phase Locked Loop often used in CPM systems as alternatives to a mixing scheme.

Therefore, a system and method is desired to reduce out of band spectral emissions through filtering which eliminates many of the problems, stated above, which are associated with traditional RF spectral emission filtering methods.

### SUMMARY OF THE INVENTION

The transmitter and associated method of the present invention removes at least some out of band spectral emissions through filtering, but eliminates many of the problems associated with traditional filtering methods by splitting the filter in two parts, applying one part of the filter at the baseband or IF, and the other part at the transmitter output frequency.

According to one embodiment of the present invention, a transmitter is disclosed that includes a phase modulator, a power amplifier and an amplitude modulator. The phase modulator receives a signal and modifies the phase of the signal. The power amplifier then receives the phase modified signal from the phase modulator and amplifies the phase modified signal. Finally, the amplitude modulator, such as digitally controlled attenuator with analog control an attenuator controlled by digital or analog signals digitally controlled attenuator, modifies the amplitude of the amplified phase modified signal. Advantageously, the phase modification and the amplitude modification are selected such that the combined effect reduces the out of band spectral emissions of the transmitted output signal.

According to one aspect of the invention, the amplitude modification is introduced after any non-linear elements of the trasnsmitter, while the phase modification can be introduced before any non-linear elements of the transmitter. Additionally, the transmitter can include an upconverter for mixing the phase modified signal with a carrier signal at a carrier frequency prior to the amplitude modification. By splitting the two parts of the filter, namely, the phase modification and the amplitude modification, and injecting the amplitude modification at the carrier frequency following all non-linear elements, including the power amplifier, the transmitter and associated method reduce out of band spectral signals while preventing distortion of the amplitude modulation. According to another aspect of the invention, the power amplifier is a non-linear power amplifier and the phase modulator directly modulates the non-linear power amplifier.

According to one embodiment of the invention, a method for removing at least some out of band signals from a signal output by a transmitter including at least one non-linear element is disclosed. The method includes predetermining, for each of a plurality of different input signals, an amplitude modification and a phase modification of the respective input signal which would remove out of band spectral emissions from the transmitted output signal. The method of this embodiment also stores the amplitude modification and the phase modification, and independently applies the amplitude modification and phase modification to the input signal in such a manner that the amplitude modification is introduced after any non-linear elements of the transmitter, thereby avoiding any distortion of the amplitude modification otherwise created by the non-linear elements. By storing the desired amplitude and phase modifications for each of a plurality of different input signals, the transmitter and method of the present invention can look up the amplitude and phase modifications for a particular input signal in an efficient and reliable manner.

According to another embodiment of the present invention, a transmitter for improving the spectral characteristics of a transmitted output signal, is disclosed, the transmitter including a modulator, the modulator receiving a digital signal sample and subjecting the digital signal sample to a first filter for determining phase shift and amplitude variation information produced by the filter, and a table for storing the phase shift and amplitude variation information, wherein phase shift and amplitude variation information is received from the table in response to a digital signal input, such that the phase shift and amplitude variation information can be independently applied to the digital signal input to produce a modulated signal, such that the filter can be eliminated. Furthermore, the transmitter can include a second filter in communication with the first filter, for reducing the power spectrum of the output signal.

In summary, the transmitter and associated method of the present invention implements a filter typically utilized to minimize out of band spectral emissions by applying a phase shift and amplitude modification separately, which, when combined, mirror the effect of the filter. Because the filter is broken into phase shift and amplitude modification components, the transmitter and associated method of the present invention does not suffer from many of the problems incurred by conventional transmitters that utilize a single filter, either before or after the power amplifier. This is because the amplitude modification can be introduced after non-linear elements of the transmitter such that the amplitude modifications are not distorted by any non-linear element. By separately modifying the phase upstream of the power amplifier, however, the phase modulator can be designed to operate at baseband or IF, thereby simplifying the design of the phase modulator..

### BRIEF DESCRIPTION OF THE DRAWINGS

FIG. 1 is a block diagram of a filter, and its corresponding effect on an input signal.

FIG. 2 is a block diagram of a transmitter with two part polar filtering, according to one aspect of the present invention.

FIG. 3 is a more detailed block diagram of the transmitter of FIG. 2, according to one aspect of the present invention.

FIG. 4 is an illustrative phase tree for MSK modulation.

FIG. 5 is a block diagram of an MSK modulator, according to one aspect of the present invention.

FIG. 6 is a plot of the real and imaginary parts of the output signal of the MSK modulator of FIG. 5, according to one illustrative aspect of the present invention.

FIG. 7 is a plot of the phase and amplitude of the output signal of the MSK modulator of FIG. 5, according to one illustrative aspect of the present invention.

FIG. 8 is a block diagram of a look-up table based waveform generator, according to one aspect of the present invention.

FIG. 9 is a plot of the power spectrum of signal modulated with a conventional filter, the frequency response of the two-part filter of the present invention, and the power spectrum of the signal following modulation with the two-part filter according to one illustrative aspect of the present invention.

FIG. 10 is a block diagram of an MSK modulator with additional filtering, according to one aspect of the present invention.

FIG. 11 is a block diagram of a look-up table based waveform generator, according to one aspect of the present invention.

FIG. 12 is a block diagram of a transmitter, according to one aspect of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

A summary of mathematical expressions illustrating the effect of a filter impulse response on a signal, as in conventional RF transmitters, will first be presented to establish the foundation and function of a transmitter and associated methods according to the present invention. Thereafter, the present invention will be presented with reference to figures illustrating several implementations of the transmitter and associated method. Finally, examples of the transmitter and associated method of the present invention will be presented with respect to illustrative embodiments to further explain the functions and features of the transmitter and associated methods.

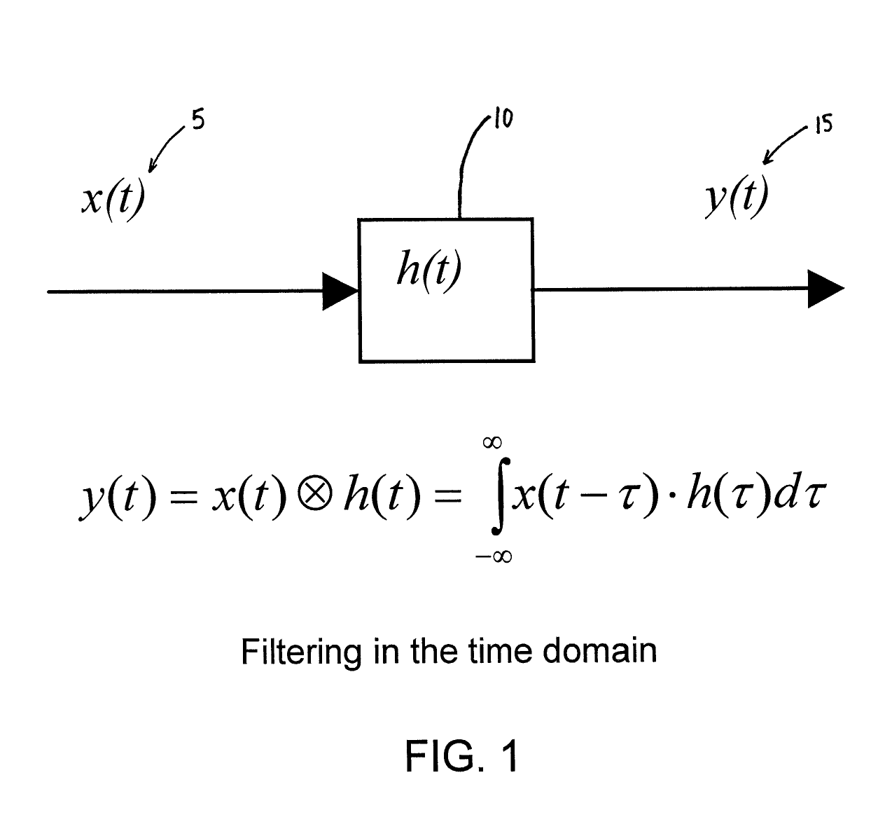

FIG. 1 illustrates a time domain signal x(t) 5 passed through a filter 10, such as a filter typically utilized to minimize out of band spectral emissions in RF transmitters. As will be appreciated by those of skill in the art, the filter output y(t) 15 is the convolution of the input signal 5 and the filter's impulse response h(t). It is possible to express the filter output y(t) 15 with an equation, in which the convolution is expressed as:

$$y ( t ) = x ( t ) ⊗ h ( t ) = {\int }_{- ∞}^{∞} x ( t - τ ) \cdot h ( τ ) ⅆ τ$$

as shown in FIG. 1. As indicated by the equation, the output y(t) 15 of the filter 10 is the convolution of the input signal x(t) 5 and the filter's impulse response h(t). As is known in the art, the convolution can also be expressed in terms of an instantaneous gain g(t), and a phase shift, φ(t), which are produced by the convolution of the input signal and the filter's response. The output y(t) expressed in terms of the input signal x(t), an instantaneous gain g(t), and a phase shift φ(t) is illustrated in the following equation:

y(t)=x(t)\mathring{×}h(t)=x(t)·g(t)·e^{j·φ(t)}

In this equation, the amplitude variation, or instantaneous gain, g(t), can be represented as:

g(t)=|y(t)/x(t)|

and the phase shift, or phase variation, φ(t), is represented by:

φ(t)=arg(y(t)/x(t))=arctan(Im(y(t)/x(t))/Re(y(t)/x(t)))

The above equations are presented to illustrate that when a particular input signal x(t) 5 and a given filter impulse response h(t) are known, both g(t) and φ(t) can be calculated, due to the fact that there are two equations, and two unknowns. These equations can be further defined mathematically where the input signal is a modulated baseband signal, which is then filtered, as has been accomplished in prior designs and as described above. If the input signal x(t) 5 is a modulated baseband signal it will be appreciated that the signal x(t) 5 can be written in the form:

x(t)=A(t)·e^{j(θ(t))}

where A(t) is the envelope of the signal, and θ(t) is the phase of the signal. When this signal is convoluted with the filter's impulse response h(t), the filtered output signal y(t) 15 can be written in the form:

y(t)=g(t)·A(t)·e^{j(θ(t)+φ(t))}

A transmitted output signal z(t) (not illustrated in FIG. 1) may then be determined, as the transmitted output signal z(t) that is produced when a carrier is added to the filtered baseband output signal y(t) 15. The transmitted output signal z(t) can therefore be expressed as:

z(t)=Re(y(t)·e^{jω}^{_{c}}^{·t})=Re(g(t)·A(t)·e^{j(ω}^{_{c}}^{·t+θ(t)+φ(t))})=g(t)·A(t)·Re(e^{jω}^{_{c}}^{·t}·e^{j(θ(t)+φ(t))})

From the equation above it can be seen that the filter 10 may be equivalently expressed as modifying the output signal by adding a phase shift, φ(t), and an amplitude variation, g(t). The present invention takes advantage of this observation, and breaks the filter 10 into two separate components. For a pure CPM signal the modulation envelope, A(t), is constant and the filter 10 is the only cause of amplitude variation in the transmitted signals' envelope.

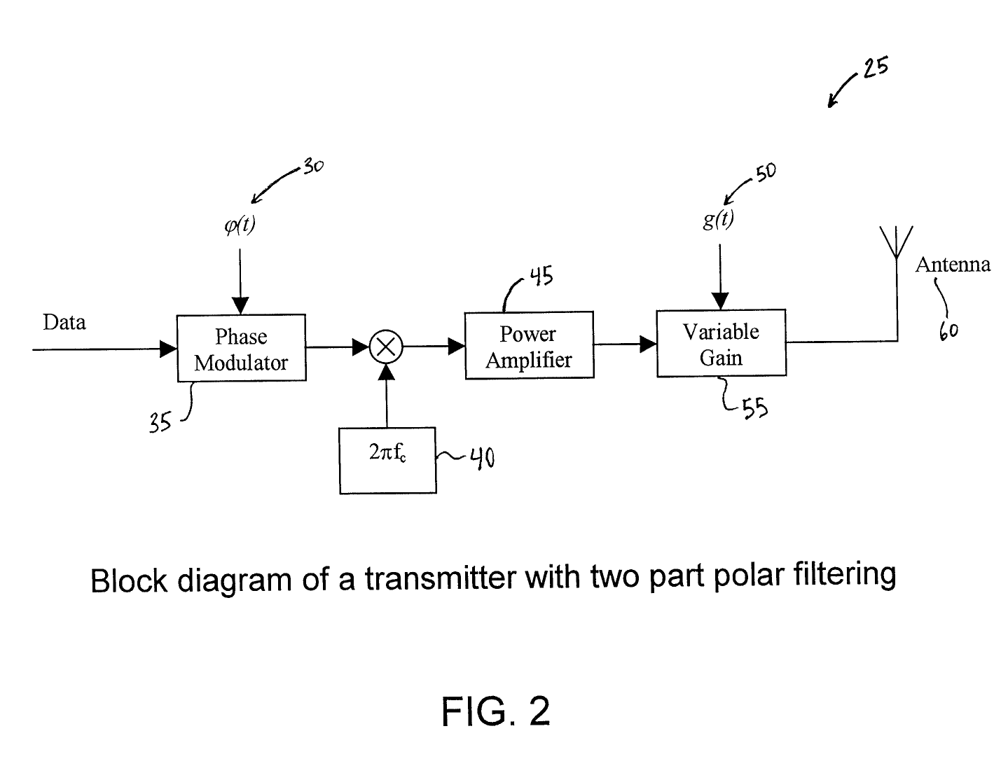

The transmitter and associated method of the present invention implement the filter 10 by applying the phase shift and amplitude modulation separately. The phase shift and amplitude modulation are selected, however, such that the combined effect of the phase shift and amplitude modulation is identical to the effect of the filter. However, because the filter 10 is broken into phase shift and amplitude modulation components, the transmitter and associated method of the present invention does not suffer from many of the problems incurred by conventional transmitter systems and methods. In particular, since the amplitude modulation can be introduced after non-linear elements of the transmitter, typically at the carrier frequency, the non-linear elements will not distort the amplitude modulation. However, the phase shift can still be introduced at baseband or IF in order to simply the design of the phase modulator since the non-linear elements will not appreciably effect the phase shift. One embodiment of the transmitter and associated method of the present invention will next be described with respect to FIG. 2.

FIG. 2 is a block diagram illustrating a transmitter 25, according to one aspect of the present invention. As shown in FIG. 2, the transmitter 25 of the present invention utilizes two part filtering to improve (i.e., decrease) the Adjacent Channel Power of a transmitted signal. As a result, the transmitter of the present invention minimizes out of band spectral emissions through filtering, while eliminating many of the problems associated with traditional methods by splitting the filter into two parts. More specifically, part of the filter can be applied at baseband or IF and the other part at the transmitter output frequency. First, by inserting the amplitude modulator, g(t) 50, after all non-linear components in the transmitter chain and at the carrier frequency, the filtering is unaffected by any non-linearity of transmitter components, such as the power amplifier 45, thus overcoming problems of prior implementations that filtered the amplitude of the signal before non-linear components. This design enables the transmitter 25 to implement one function of filtering, amplitude modulation, without resulting in the undesirable consequence that non-linear components will distort the amplitude modulation.

According to the present invention, the second component of the filter, as described above, is the phase shift φ(t). However, because the phase shift φ(t) is not affected by non-linear components to the same extent as the amplitude modulation, the phase shift may be inserted at an arbitrary point in the signal chain, for example, at baseband. As will be appreciated by those of skill in the art, for CPM, the phase shift φ(t) 30 may efficiently be implemented or inserted with a phase modulator 35, as is shown in FIG. 2. By introducing the phase shift at baseband, the design of the phase modulator can be simplified relative to phase modulation that occurs at higher frequencies, such as at the carrier or output frequency of the transmitter. The input signal can thereafter be phase modulated and convoluted with a carrier signal having a carrier frequency 40, such as by means of an upconverter including, for example, a Phase Lock Loop (PLL). The upconverted signal can then be amplified by a power amplifier 45, as in conventional transmitters. Following amplitude modulation, the output signal can be transmitted via an antenna 60.

Although the amplitude variation g(t) 50 is illustrated as being introduced after the non-linear power amplifier 45, it should be appreciated that the amplitude variation g(t) 50 may also be inserted by directly modulating the non-linear power amplifier 45. Although the output power is not a linear function of input power in non-linear amplifiers, non-linear amplifiers typically have one or more parameters that have a generally linear relationship to the amplifier output, such as supply or bias voltages. Thus, by modulating one or more of these parameters the amplitude variation can be introduced without non-linear distortion. However, a more precise amplitude modulation may be achieved using an attenuator with analog control or a digitally controlled attenuator after the power amplifier 45.

An attenuator is simply a variable gain amplifier with gain less than 1. The present invention can utilize one of two types of attenuators suitable for use with the present invention. A first type of attenuator that may be used, a digitally controlled attenuator (also referred to herein as a digitally controlled attenuator), is one that is controlled by one or more digital signals selecting one or more fixed levels of attenuation. It can be implemented as a resistive divider with switches selecting different resistors. The implementation of the switches may be implemented with PIN diodes, or other methods known to those of ordinary skill in the art. The second type of attenuator that may be used, a attenuator with analog control, utilizes an analog control signal to set the desired level of attenuation. This type of attenuator could also be built using a PIN diode, creating different levels of attenuation by changing the impedance of the diode by varying the bias current. However, it will be appreciated that using an attenuator with analog control requires converting the digital amplitude signal produced by the invention to an analog signal with a D/A converter.

Generally, an attenuator reduces its output signal by introducing loss and dissipating the unwanted portion of the signal as heat. It should be appreciated that for conventional CPM transmitter schemes, typical amplitude variations introduced by a filter will be small, usually less than 10%. Because of this small variation, it may be sufficient to utilize an attenuator with coarse quantization, such as an attenuator with 8 or 16 quantization. However, it should be appreciated that linearly adjustable attenuators may lack the stability and precision required to accurately reproduce amplitude variations over the full range of a transmitter's operating conditions. Furthermore, the quantization noise introduced by a switched attenuator may be reduced using one or more familiar techniques from digital signal processing. For example, noise shaping techniques (e.g. Delta-Sigma Digital to Analog conversion) and the number of quantization levels may be increased. Nevertheless, one advantageous aspect of the transmitter and associated method of the present invention is the insertion of the amplitude variation g(t) 50 after non-linear components of the transmitter, rather than the particular manner in which the insertion of the amplitude variation g(t) 50 is accomplished.

As noted above, the phase and amplitude functions, φ(t) and g(t), are dependent on the data and the filter impulse response, h(t), and the equations discussed above with respect to FIG. 1 can be used to calculate the value of φ(t) and g(t). These values can also be determined by passing the modulated baseband signal through the filter, h(t), and measuring the instantaneous change in phase between input and output, φ(t), and the instantaneous change in amplitude, g(t).

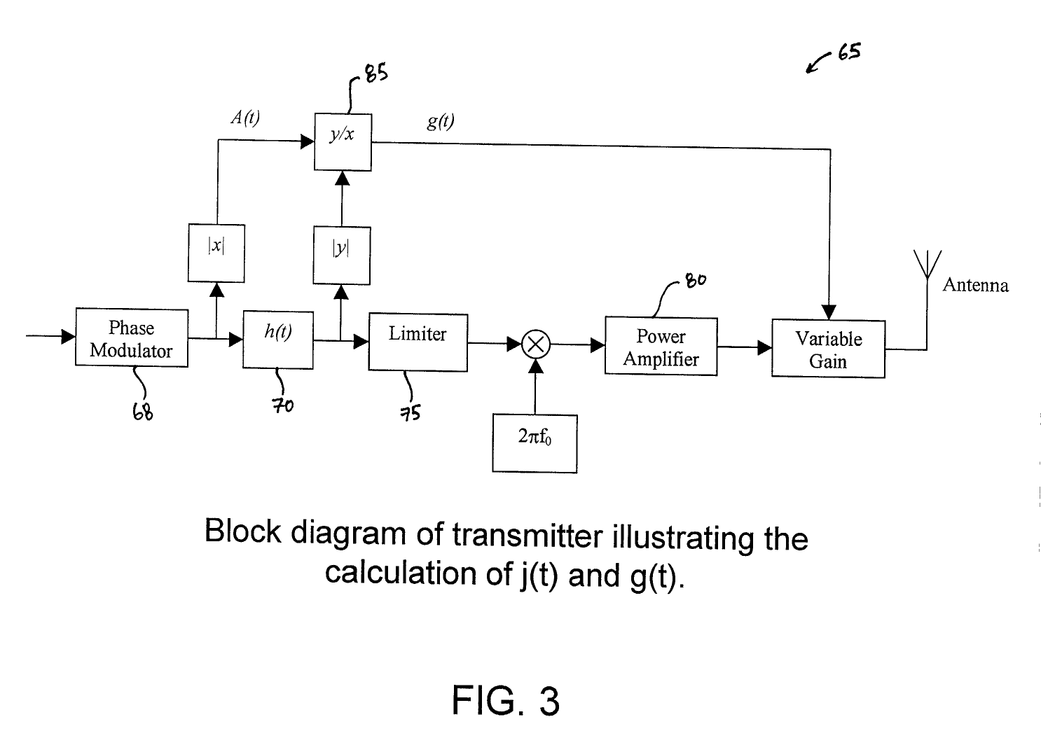

FIG. 3 is a block diagram which is the mathematical equivalent of FIG. 2, and is described for purposes of illustrating the operation of the transmitter and method of the present invention. While the transmitter of FIG. 3 includes a phase modulator 68 as in the embodiment of FIG. 2, the phase modulator does not modulate the signal for purposes of filtering by applying a phase shift of φ(t). In this regard, φ(t) is indicated as an input to the phase modulator 35 of FIG. 2, while the phase modulator of FIG. 3 has no similar input. As depicted by the block diagram of FIG. 3, however, a phase shift φ(t) is applied directly by the filter 70, which eliminates the need to explicitly calculate φ(t). Since filter 70 is a conventional filter, the filter 70 introduces an amplitude modulation in addition to the phase shift, which, as stated above, may be undesirable prior to non-linear elements in the transmitter. As such, the transmitter of FIG. 3 also includes a limiter 75 for removing the amplitude variation g(t). However, the amplitude variation g(t) is explicitly calculated by the divider 85 as the ratio of filter input (magnitude of the unfiltered signal) to output envelope (magnitude of the filtered signal). According to the present invention, the amplitude variation g(t) is then reintroduced by the variable gain element 82 after the non-linear power amplifier 80 in order to avoid amplitude distortion. However, it should be appreciated that where the magnitude of the unfiltered signal |x↑ is constant, such as in constant envelope modulation schemes, the divider 85 may be eliminated, and the amplitude directly reintroduced by an attenuator or other variable gain devices following the power amplifier.

Although the present invention is useful in overcoming problems associated with filtering either analog or digital signals, one of the greatest benefits of the two part filtering of the present invention is realized if the baseband is implemented digitally, as will be appreciated with reference to the examples described below. In this regard, the transmitter and associated method of the present invention makes it possible and beneficial to pre-calculate the values of φ(t) and g(t) that would reduce or, more preferably, minimize the out of band signals that would otherwise result from each of a plurality of different input signals. The precalculated values of φ(t) and g(t) could then be stored in a table such that each value will not be required to be determined repeatedly by the transmitter. In order to further improve the two part filtering provided by the present invention, the sum of θ(t) and φ(t) (i.e. the sum of the phase modulation and the filter phase) may be stored in the same table to reduce the number of tables. Reducing the number of tables by consolidating the impact of two filters into a single table reduces the size and complexity of the implementation. Other techniques, such as interpolation, may also be deployed to reduce the table size. The implementation of the present invention using such tables will be described in detail with reference to the following illustrative examples.

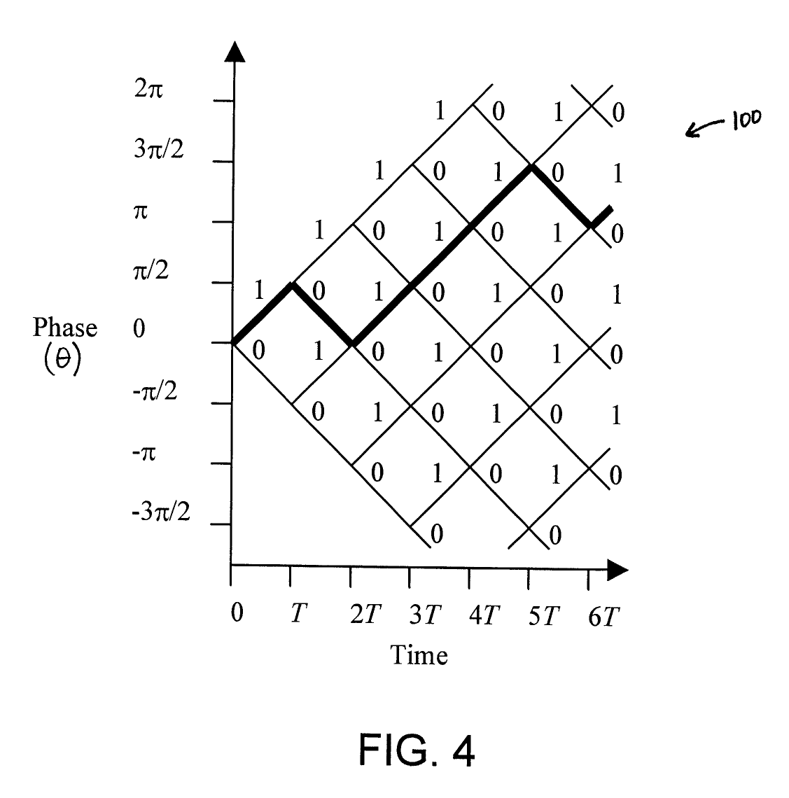

A transmitter according to one embodiment of the present invention will next be illustrated with respect to improving the ACP performance of Minimum Shift Keying (MSK) modulation. It will be appreciated that the transmitter of this embodiment functions just as the transmitter of FIG. 2, where the phase shift and amplitude modulation are introduced separately by the transmitter. However, in this embodiment, the phase shift and amplitude modulation required to appropriately filter an input signal have been precalculated and stored for a variety of different input signals. First, however, it should be appreciated by those of skill in the art that MSK modulation is a form of Digital Continuous Phase Modulation where a binary 1 is transmitted as a positive 90 degree phase shift and a binary 0 is transmitted as a negative 90 degree phase shift. One way to represent the modulation of the transmitted signal is using a phase tree, which shows all possible phase trajectories of the modulation as a function of time. FIG. 4 shows an illustrative phase tree 100 for MSK modulation, having a trajectory corresponding to a transmitted binary data sequence of 1011101, where T is the bit period. As shown in FIG. 4, for each binary 1, there is a positive 90° phase shift, as indicated on the vertical axis by π/2 and for each binary 0, there is a negative 90° phase shift of −π/2.

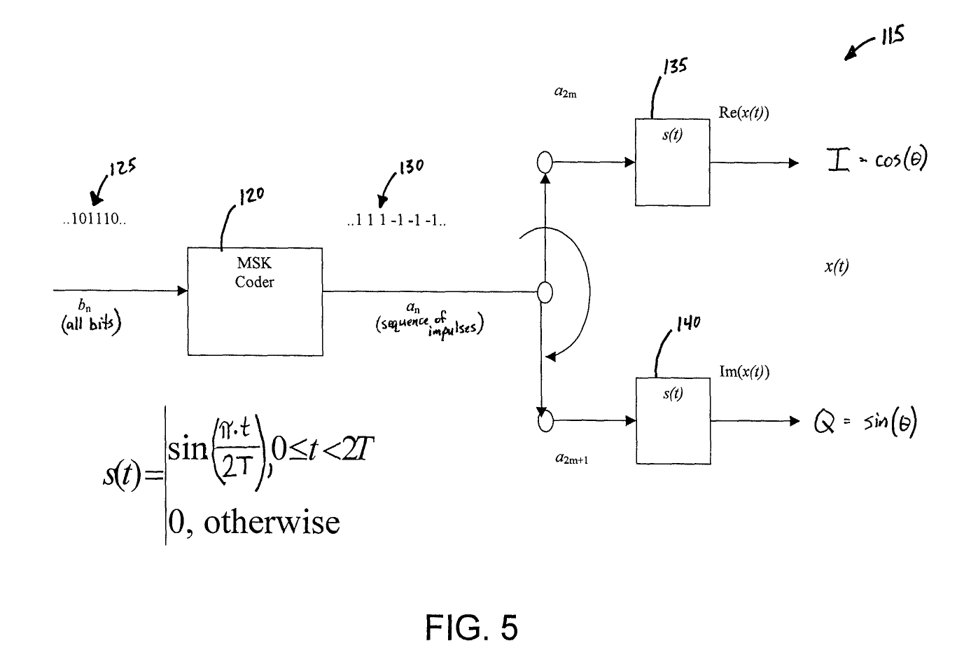

To implement the transmitter and method of the present invention, the incoming data sequence is first applied to a phase modulator, as in the transmitter of FIG. 2, which applies a phase shift to the data. According to this illustrative embodiment, the phase modulator may be implemented through the use of a MSK modulator 115, a block diagram of which is illustrated in FIG. 5. The MSK modulator 115 of FIG. 5 performs the same function as that of the phase modulator in FIG. 2. The MSK modulator 115 includes a MSK coder 120 for performing digital data to symbol mapping, which converts the binary data sequence input of ones and zeros 125 to a converted sequence of +1 and −1s 130, or a series of pulses, as known to those skilled in the art. The converted sequence is then passed through pulse shaping filters 135, 140 to achieve the phase shift. More specifically, according to the illustrative embodiment, the phase shift is implemented by passing the converted sequence through pulse shaping filters 135, 140 having an impulse response s(t) that is equivalent to a positive sine half cycle, as illustrated by the equation shown in FIG. 5.

The two pulse shaping filters 135, 140 are used to implement the phase shift, one producing the real portion of the output signal, and the second producing the imaginary portion of the output signal. These are then added together to produce the output signal x(t). It should be appreciated by those of skill in the art that the imaginary portion of the signal is equal to the sine of the phase of the binary data, and the real portion is equal to the cosine of the phase of the binary data. Passing the sequence of pulses through these filters essentially reproduces the impulse response of the respective pulse shaping filters for each pulse, and the sum of these impulse responses is the output of the filters. Thus, the outputs of the filters are the two components of the baseband signal, and these components are used to modulate the carrier to produce the transmitted output signal.

Mathematically, the operation performed by the modulator 115 of FIG. 5 is:

$$x ( t ) = {\sum }_{n} \sqrt{{( - 1 )}^{n}} \cdot {a}_{n} \cdot s ( t - nT )$$

where T is the bit period and a is the binary data sequence converted to impulse values of plus and minus one by the MSK coder 120. According to the present illustrative example, the length of the pulse shaping filters' impulse response is time limited to two bit periods, and as a result, the output x(t) is a function of only two aₙ samples (i.e., two binary impulses) at any one point in time. The modulator receives a sequence of impulses, and such that at each point in time the output of the modulator depends on two of the impulses. If the length of the filter's response is increased, the output can depend on a larger number of impulses. Limiting the filter's impulse response to two bit periods results in a pulse-shaping filter output dependent upon only two impulse responses, which makes the modulator 115 easier to implement. However, to generate the output x(t) for a filter with an increased response length, the modulator 115 would be required to have more memory, as the modulator output would depend upon a large number of input samples. The remaining description of the MSK is predicated upon the output x(t) as a function of two binary impulses, due to ease of implementation, although any number of binary impulses may be used for a respective filter impulse response.

Continuing with the illustrative MSK example, in a sampled system, the impulse response, s(t), is represented by a number of samples, sᵢ, one sample for each impulse of the sequence of impulses. If, for example, the sample frequency, fₛ, is eight times the bit rate (i.e. Tfₛ=8), then s(t) can be stored as 16 samples (2Tfₛ=16), due to the fact that the filter response is two bit periods long and there are 8 samples per bit period. Thus, each output sample, xₖ, is the sum of two samples from sᵢ, each multiplied by a sample from aₙ. In other words, in the present illustrative embodiment, the output samples can be calculated by adding two samples from s_{I,}, the sine of each sample determined by a sample from aₙ. The sampled version of the pulse-shaping filter is illustrated in FIG. 5 as s(t). Using the fact that sᵢ is zero for all values of i outside the range of 0 to 2Tfₛ, the time discrete version of the operation performed by the modulator 115 can be written as:

Xₖ=a_{2(k div 2T·f}_{ₛ}₎·S_{(k mod 2T·f}_{ₛ}₎+j·a_{2((k-T·f}_{ₛ}_{) div 2T·f}_{ₛ}₎₊₁·S_{((k-T·f}_{ₛ}_{) mod 2T·f}_{ₛ}₎

This equation makes it clear that each output sample depends on only two samples from aₙ.

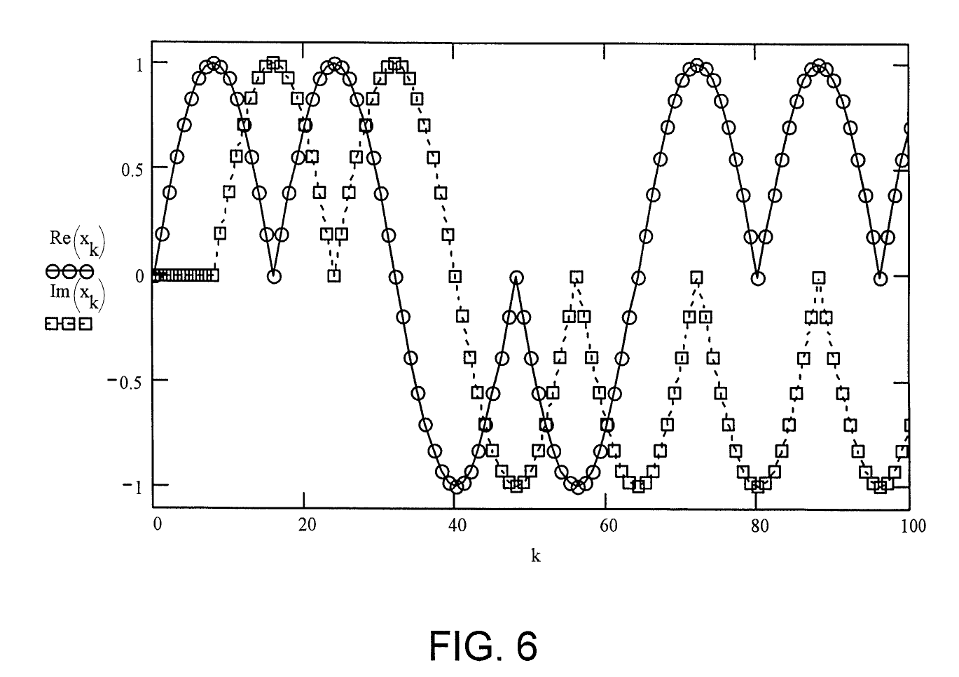

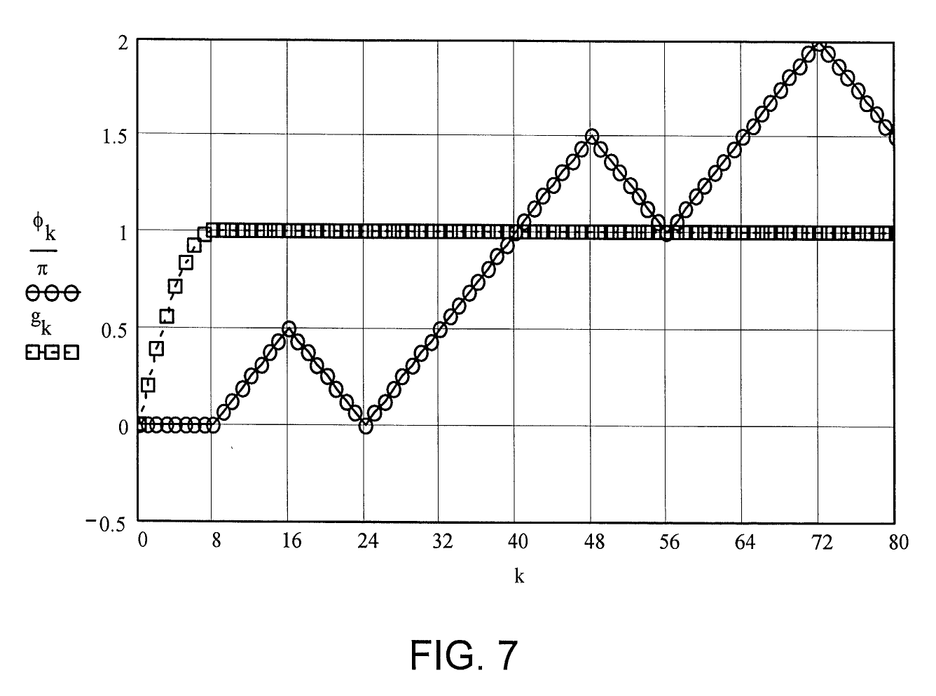

FIG. 6 illustrates graphically the output of the MSK modulator 115 of FIG. 5 by showing the first 80 samples of xₖ where, for instance, Tfₛ=8 and aₙ=1 1 1 1 −1 −1 −1 −1, where aₙ is the translated sequence generated by the MSK Coder 120 from data bit inputs. FIG. 6 shows a plot of the real and imaginary parts of xₖ, where the circles indicate real samples and the boxes indicate imaginary samples. FIG. 7 shows the same data plotted in polar form, where the circles indicate phase samples and the boxes indicate amplitude samples. The phase of the modulation of FIG. 7 clearly reveals the transmitted data sequence, 1011101, as in FIG. 4. As explained above, the length of the impulse response is 2Tfₛ, which in this case equals 16 samples. Therefore, it will be appreciated by those of skill in the art that a table storing all possible output waveforms can be generated requiring 64 entries (2 data bits×2 possible values×16 samples=64). Although this table is not required to implement the present invention, it is advantageous to use such a table to store phase and amplitude information for any digital inputs so that outputs can be efficiently generated with little delay, that is, the phase shift and amplitude modulation can merely be looked up for a given input sequence as opposed to being repeatedly calculated. In the Cartesian case (FIG. 6), each entry consists of a complex sample. In the polar case (FIG. 7), each table entry consists of an amplitude and phase sample. Of course, with constant envelope modulation, the amplitude information, as in the present illustrative embodiment and as will be appreciated with reference to FIG. 7, is constant.

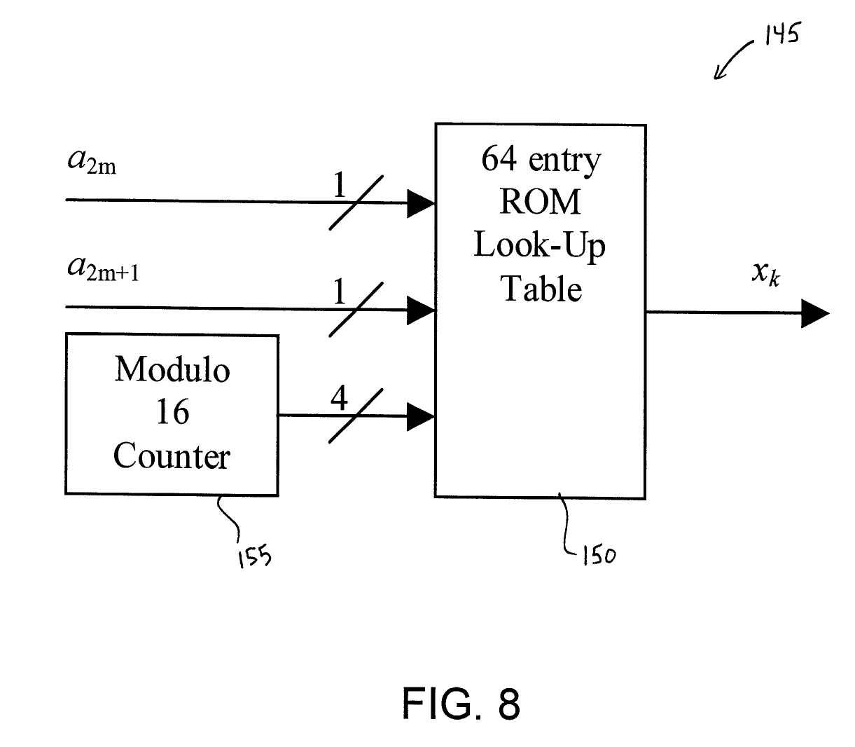

FIG. 8 illustrates a possible implementation of a table-based waveform generator 145 for implementing one embodiment of the present invention. More specifically, FIG. 8 is a block diagram of a look-up table based waveform generator 145, wherein all possible output waveforms of the MSK modulator 115 of FIG. 5 are stored in a look-up table 150, typically located in a memory device, such as ROM, of the transmitter. By appropriately indexing or addressing the look-up table 150, the desired sample output waveform, such as the sample waveform generated by the MSK modulator 115 of FIG. 5, will be output. The symbol data output from the MSK coder 120, together with a counter 155 providing fractional symbol timing, addresses the table 150.

As illustrated in FIG. 8, continuing with the MSK example of FIG. 4, each output sample depends on two data bits, which determine the output over a period of 16 samples. The counter, in this case a 4 bit counter as there are 16 samples, indexes the 16 output samples selected by the two data bits. New data bits are applied alternately to the data inputs every 8 samples (see FIG. 5). For example, new data bits may be applied every time the counter reaches zero and eight. The value of the data bits together with the counter value selects the appropriate sample in the sequence for this particular data combination. The counter increments for every output sample, addressing the next sample, and continues doing so when wrapping around to zero.

Thus, by pre-determining all possible outputs, including phase and amplitude modulation information and storing this information in a table, for any combination of input signals, the table-based waveform generator 145 can output the real and imaginary parts of the output sample, such that these values need not be separately determined by the MSK modulator 115 for each input. The table 150 may be implemented by any well known means in the art, such as a ROM array, so long as the table is addressable based upon the input data, and produces an output which may be further processed by the transmitter of the present invention. It should be appreciated that the size of the table 150 will increase exponentially with the length of the filter's impulse response. However, it may possible to reduce the size of the look-up table 150 through different techniques, for example by taking advantage of the symmetrical properties of the impulse response. For instance, in a MSK pulse shaping filter, the shape of the impulse response is a positive sine half cycle. However, because sine(x)=sine(π−x), values must be stored only for the first 0−π/2. Because the second half, π/2−π, is a mirror image of the first and, using addressing, the same table values can be used. For negative input data, the output is a negative sine half cycle. The only difference is the sign of the output, so the same table data can be used as a positive cycle where the sign of the table output is inverted. Combine these techniques and the table size can be reduced to 25% of the original table, at the expense of more complex addressing scheme and a the addition of a conditional sign inversion block.

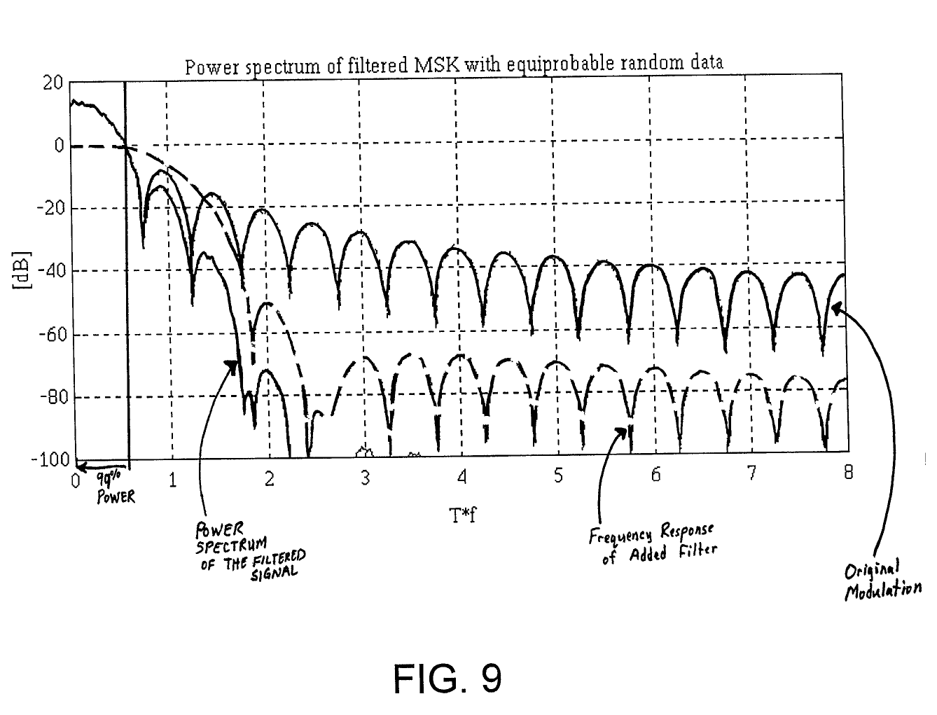

FIG. 9 illustrates a simulated power spectrum of the MSK modulated output based upon the look-up table of FIG. 8, which is the digital equivalent of the MSK modulator output. As can be seen from the figure, the occupied bandwidth, i.e. the bandwidth containing 99% of the signal power, is approximately 1.2 times the data rate. The power spectrum has a main lobe and several side lobes, and the useful signal is for all practical purposes contained within the main lobe. Additionally, the width of the main lobe is approximately 1.5 times the data rate. The side lobes have little useful signal power, but may cause significant interference to a receiver on a neighboring channel. With the modulation provided by a conventional transmitter as designated as the original modulation in FIG. 9, even the 1% power (side lobes) can significantly interfere with reception of a distinct signal, if the receiver is located near to the transmitter due to the power in the side lobes of the transmitted signal. Therefore, it is desirable for the side lobe power to fall off rapidly in order to improve the spectral performance of the transmitter.

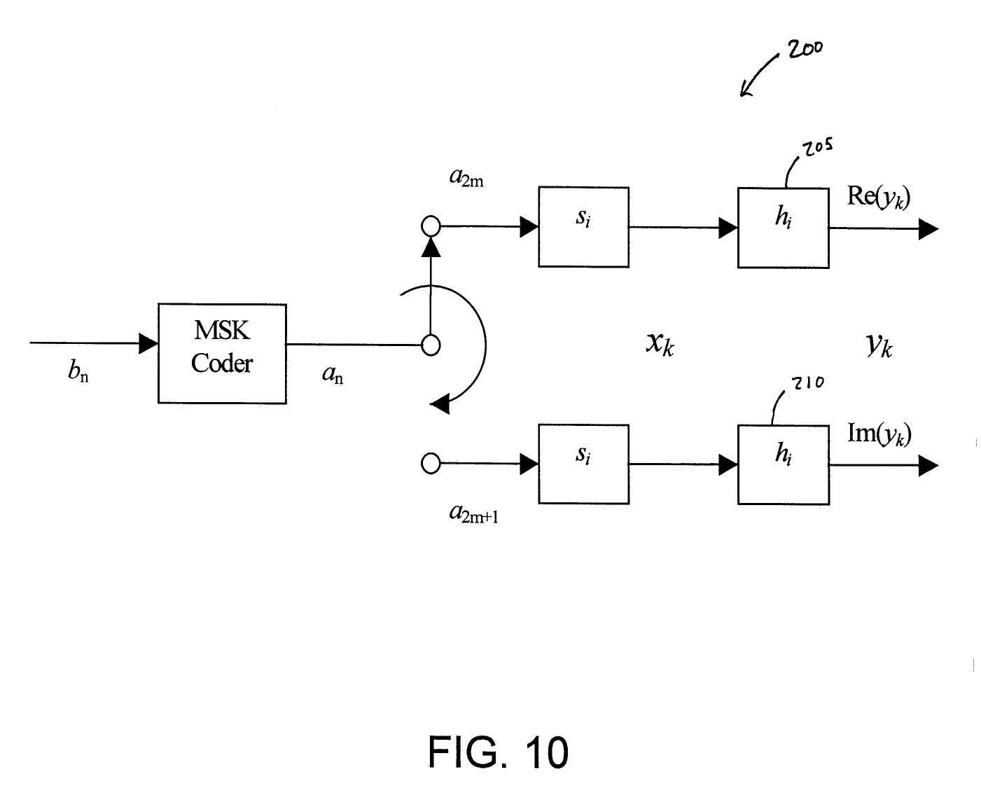

Therefore, according to another embodiment of the invention, the transmitter includes a second filter, in addition to the pulse-shaping filters of FIG. 5, to reduce the side lobes (i.e., transmitted power) to an acceptable level. The introduction of the filter 205 is illustrated in FIG. 10. However, the length of the added filter's impulse response will greatly affect the complexity of the modulator. As stated above, a long impulse response increases the modulator memory, making each output sample depend on a larger number of data bits and increasing the number of possible signal trajectories. On the other hand, a short impulse response has a slower transition between pass band and stop band, which may cause distortion of the main lobe, illustrated in FIG. 9.

According to one aspect of the present example, wherein the transmitter includes an additional filter, a short impulse response is desirable. As a result, according to one aspect of the present invention, a FIR filter may be utilized because FIR filters have good phase characteristics. However, it should be appreciated that any filter having a relatively short impulse response may be used. For the purpose of this example, a low-pass FIR filter with a length of 2T can be implemented, where the filter bandwidth is adjusted to cause minimal interference with the main lobe while providing approximately 20 dB of attenuation of the second side lobe. It should be appreciated that the filter should have level pass characteristics in the 99% power spectrum of the signal so that minimal interference occurs as a result of the filtering, as shown in FIG. 9. FIG. 9 also shows the frequency response of the added filter and the power spectrum of the filtered signal. The solid line is the power spectrum of the filtered signal, and the dashed line is the frequency response of the added filter. The advantage of the added filter can be appreciated by comparing the original modulated signal to the filtered signal. The side lobe power drops substantially in comparison to the side lobe power of the originally modulated signal. However, because of the introduction of this filter, the filtered modulation is no longer constant envelope. On the other hand, the amplitude variations introduced by the filter can be fairly small. For the example illustrated in FIG. 9, the difference between the peak and minimum amplitude is less than 7%.

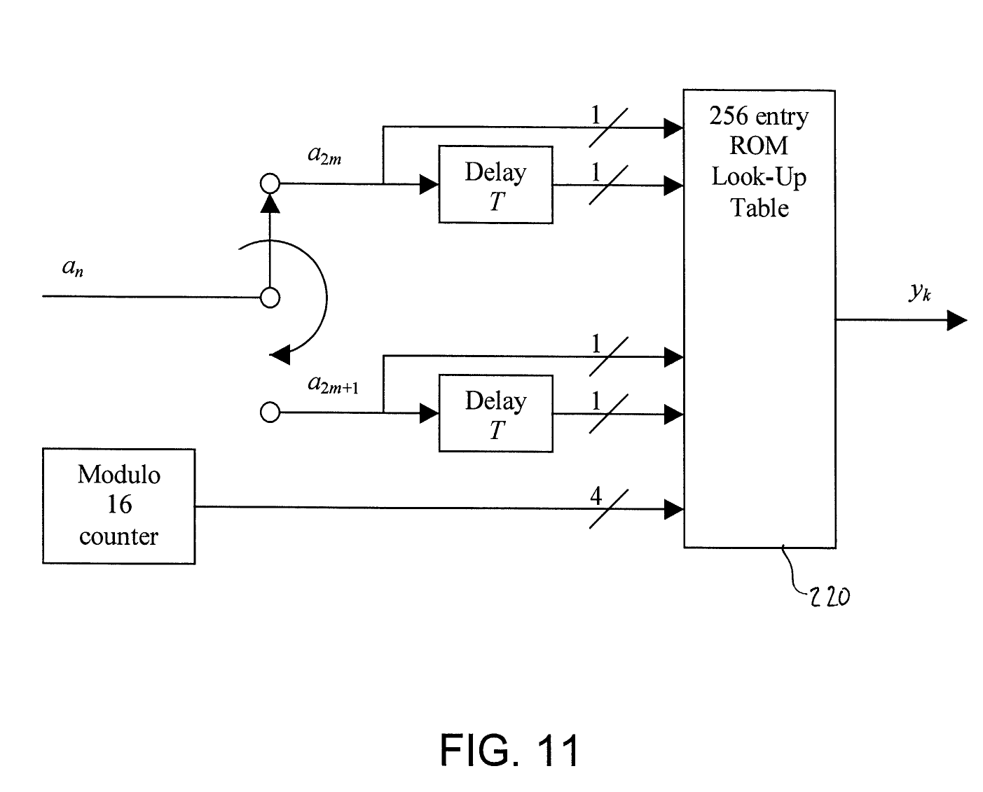

Given that both the pulse shaping filter and the additional filter 205 are 2T long, the resulting cascaded filter response is 4T long. Thus, each output sample, yₖ, is a function of 4 data bits. This results in a look-up table quadruple the size of the look-up table 150 of the table based waveform generator 145 of FIG. 8. FIG. 11 shows a Look-Up Table 220 based waveform generator that offers spectral improvement when used in conjunction with the modulator of FIG. 10. While the table entries could be stored in Cartesian coordinate format, each table entry is typically stored in polar format, i.e. a phase and a amplitude sample. It should be appreciated that unlike the MSK modulated signal resulting from the modulator of FIG. 5, there is amplitude variations produced by the modulator of FIG. 10. As described above, however, the phase sample is preferably applied at baseband with the amplitude variations generally stripped out by the subsequent upconversion to the carrier frequency such that the amplitude modulations can be thereafter introduced at the output or carrier frequency.

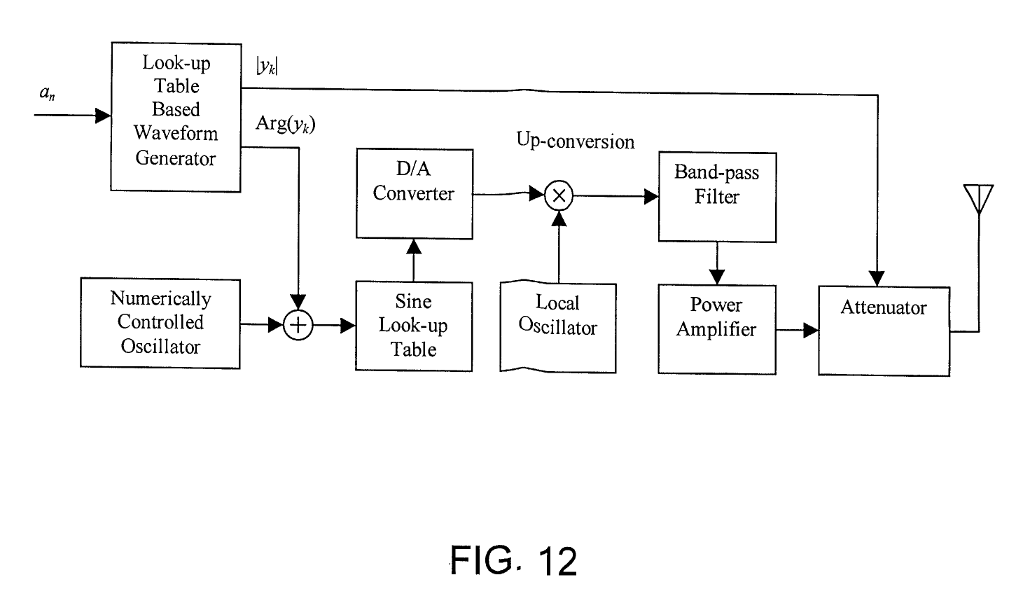

FIG. 12 shows a block diagram of transmitter according to one aspect of the present invention implementing polar filtering to improve spectral performance. FIG. 12 shows how the table based waveform generator of FIG. 11 can be used in a transmitter by directly phase modulating a Direct Digital Synthesizer and applying the amplitude variation through the means of an attenuator, after the power amplifier.

Although the present invention has been described herein with respect to an analog transmitter in which the phase modulation and amplitude modulation were introduced separately, and with reference to transmitters utilizing look-up tables to store and produce phase and amplitude information based upon certain input bit sequences, both embodiments of the invention are founded upon the same advantageous principle. That is, the transmitter and associated method of the present invention separately introduce the phase shift and amplitude modulation such that a phase shift can be accomplished at baseband or IF without simultaneously introducing amplitude modulation that could be distorted when subjected to non-linear transmitter components, such as the PLL or a power amplifier. Instead, the amplitude modulation can be introduced after the non-linear elements, typically at the carrier frequency, in order to avoid deleterious distortion. This two-part filtering can be accomplished using analog or digital signals. Additionally, where digital signals are input into a transmitter of the present invention, phase and amplitude information can be stored and looked up in a ROM table so that modulated outputs can be quickly selected without requiring a modulator to compute phase and amplitude information for each input signal. Furthermore, an additional filter can be added to the modulator such that the power spectrum of the modulated signal will only generate insignificant side lobes.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A transmitter for removing at least some out of band signals from a transmitted output signal having a predetermined bandwidth, comprising:
a phase modulator for receiving a signal and modifying the phase of the signal;
a power amplifier for receiving the phase modified signal from the phase modulator and amplifying the phase modified signal;
a amplitude modulator for receiving the amplified phase modified signal and modifying the amplitude of the amplified phase modified signal, wherein the phase modification provided by said phase modulator and the amplitude modification provided by said amplitude modulator cooperate to filter out of band signals from the transmitted output signal.

2. The transmitter according to claim 1, further comprising a non-linear element, wherein amplitude modulator is downstream of said non-linear element.

3. The transmitter according to claim 1, further comprising a non-linear element, wherein the phase modulator is upstream of said non-linear element.

4. The transmitter of claim 1, further comprising an upconverter for mixing the phase modified signal with a carrier signal at a carrier frequency prior to the amplitude modulation.

5. The transmitter of claim 1, wherein the power amplifier is a non-linear power amplifier and the amplitude modulator directly modulates the non-linear power amplifier.

6. The transmitter according to claim 1, wherein the amplitude modulator comprises a digitally controlled attenuator.

7. The transmitter according to claim 1, wherein the amplitude modulator comprises a attenuator with analog control.

8. A method for removing at least some out of band signals from a transmitted output signal having a predetermined bandwidth, the method comprising:
modifying the phase of a signal;
amplifying the phase modified signal; and
modifying the amplitude of the amplified phase modified signal, wherein the phase modification and said amplitude modification cooperate to filter out of band spectral signals from the transmitted output signal.

9. A method according to claim 8 further comprising mixing the phase modified signal with a carrier signal at a carrier frequency prior to the amplitude modification.

10. A method according to claim 8 wherein the phase modification comprises modifying the phase of the signal prior to subjecting the signal to non-linear elements, and wherein the amplitude modification comprises modifying the amplitude of the signal following operation of any non-linear elements.

11. A method for removing at least some out of band signals from a signal output by a transmitter including at least one non-linear element, comprising:
for each of a plurality of different input signals, predetermining an amplitude modification and a phase modification of the respective input signal which would remove at least some out of band spectral signals from the transmitted output signal;
storing the amplitude and phase modifications for each of the plurality of different input signals;
independently applying the amplitude modification and the phase modification to the input signal, wherein applying the amplitude modification comprises applying the amplitude modification after all non-linear elements of the transmitter.

12. The method of claim 11, wherein applying the phase modification comprises applying the phase modification prior to the non-linear elements of the transmitter.

13. The method of claim 11, wherein the transmitter comprises a non-linear power amplifier, and wherein applying the amplitude modification comprises applying the amplitude modification by directly modulating the non-linear power amplifier.

14. A transmitter for improving the spectral characteristics of a transmitted output signal, comprising:
a modulator, the modulator receiving a digital signal sample and subjecting the digital signal sample to a first filter for determining phase shift and amplitude variation information produced by the filter;
a table for storing the phase shift and amplitude variation information, wherein phase shift and amplitude variation information is received from the table in response to a digital signal input, such that the phase shift and amplitude variation information can be independently applied to the digital signal input to produce a modulated signal, such that the filter can be eliminated.

15. The transmitter of claim 14, further comprising a second filter in communication with the first filter, wherein the second filter reduces the power spectrum of the output signal.
